(19) United States
(12) Patent Application Publication
(10) Pub. No.: US 2017/0213134 A1
(43) Pub. Date: Jul. 27, 2017

(54) SPARSE AND EFFICIENT NEUROMORPHIC POPULATION CODING

(71) Applicant: The Regents of the University of California, Oakland, CA (US)

(72) Inventors: Michael Beyeler, Seattle, WA (US); Nikil D. Dutt, Irvine, CA (US); Jeffrey L. Krichmar, Cardiff By The Sea, CA (US)

(21) Appl. No.: 15/417,626

(22) Filed: Jan. 27, 2017

Related U.S. Application Data
(60) Provisional application No. 62/287,510, filed on Jan. 27, 2016.

(51) Int. Cl. G06N 3/08; G06F 17/16

(52) U.S. Cl. CPC G06N 3/088; G06F 17/16

(57) ABSTRACT

Example embodiments for efficient neuromorphic population coding are described. In one case, individual instances of input stimuli are evaluated using a set of feature encoding units to generate a population of encoded feature values. The population of encoded values for each of the individual input stimuli are arranged into a population code matrix. The population code matrix is factorized into a basis element matrix and a contribution coefficient matrix based on a number of basis vectors, where the number of basis vectors is selected to balance sparseness in the basis element matrix and reconstruction error of the population code matrix from the basis element matrix and the contribution coefficient matrix. The embodiments are compatible with neuromorphic hardware and can achieve compact representation of high-dimensional data, infer latent variables in the data, and defer processing to an off-line training phase to save time during real-time data capture and evaluation.

### CROSS-REFERENCE TO RELATED APPLICATIONS

This application claims the benefit of U.S. Provisional Application No. 62/287,510, filed Jan. 27, 2016, the entire contents of which is hereby incorporated herein by reference.

### GOVERNMENT LICENSE RIGHTS

This invention was made with government support under contract 11S-1302125 awarded by the National Science Foundation. The government has certain rights in the invention.

### BACKGROUND

As best understood, neurons in the dorsal subregion of the medial superior temporal (MSTd) of the brain area respond to large, complex patterns of retinal flow, implying a role in the analysis of self-motion. In that context, some neurons are selective for the expanding radial motion that occurs as an observer moves through the environment (e.g., heading), and computational models can account for this finding. However, ample evidence suggests that MSTd neurons may exhibit a continuum of visual response selectivity to large-field motion stimuli. The underlying computational principles by which these response properties are derived by the brain remain poorly understood. Furthermore, a computational model encapsulating these principles could have applications for reactive navigation in autonomous systems, such as robots and aerial drones.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 illustrates an example system for sparse and efficient population coding according to various examples described herein.

FIG. 2 illustrates representative flow fields according to various examples described herein.

FIG. 3 illustrates a representative example of components in the computing environment shown in FIG. 1 according to various examples described herein.

FIG. 4 illustrates a representative example of factorization used for sparse and efficient population coding according to various examples described herein.

FIG. 5 illustrates balancing factors for the selection of a number of basis vectors used for factorization according to various examples described herein.

FIG. 6 illustrates an example of a sparse and efficient neuromorphic population coding process according to various examples described herein.

The drawings illustrate only example embodiments and are therefore not to be considered limiting of the scope of the embodiments described herein, as other embodiments are within the scope of the disclosure.

### DETAILED DESCRIPTION

The embodiments are inspired by the way the mammalian visual system processes visual motion for self-movement perception. Specifically, the invention is based on a computational model of the dorsal subregion of the medial superior temporal (MSTd) area of the brain. Neurons in area MSTd have been shown to extract hidden variables such as the direction of travel, head rotation, or eye velocity from the complex patterns of optic flow that appear on the retina while moving through the environment.

In the context presented above, a computational model that is representative of the type of processing performed by MSTd is described herein. The model captures the underlying organizational and computational principles by which MSTd response properties are derived. Therefore, it is easiest to explain the inner workings of the system on the example of MST. The model is based on the hypothesis that neurons in MSTd efficiently encode a continuum (or near continuum) of large-field retinal flow patterns on the basis of inputs received from neurons in the middle temporal (MT) area of the brain with receptive fields that resemble basis vectors recovered through factorization, such as nonnegative matrix factorization (NMF).

Using a dimensionality reduction technique known as nonnegative matrix factorization, a variety of neural response properties could be derived from MT-like input features. NMF is similar to principal component analysis (PCA) and independent component analysis (ICA), but unique among these dimensionality reduction techniques in that it can recover representations that are often sparse and “parts-based.” much like the intuitive notion of combining parts to form a whole. However, other dimensionality reduction techniques that result in a set of (roughly) equally informative, additive basis vectors can be used (e.g., ICA, k-means clustering, tensor rank decomposition).

Thus, a computational model is described based on the hypothesis that neurons in the MSTd efficiently encode a continuum of large-field retinal flow patterns encountered during self-movement on the basis of inputs received from neurons in the MT. In one example of the model described herein, visual input to the model encompassed a range of two-dimensional (2D) flow fields caused by observer translations and rotations in a three-dimensional (3D) world. For example, flow fields that mimic natural viewing conditions during locomotion over ground planes and towards back planes located at various depths were used, with various linear and angular observer velocities, to yield a total of S flow fields comprising input stimuli. Each flow field was processed by an array of F feature encoding units (MT-like model units), each tuned to a specific direction and speed of motion.

The activity values of the feature encoding units were then arranged into the columns of an F×S matrix, V, which served as input for factorization. As described below, the NMF linear dimensionality reduction technique can be used to find a set of basis vectors. When the basis vectors are interpreted as synaptic weights in a neural network, any arbitrary “complex motion” pattern as well as a number of behaviorally relevant hidden variables (e.g., the current direction of travel) can be reconstructed simply by looking at the activity of all the neurons in the network.

In the context outlined above, examples embodiments for efficient neuromorphic population coding are described. In one case, individual instances of input stimuli are evaluated using a set of feature encoding units to generate a population of encoded feature values. The population of encoded values for each of the individual input stimuli are arranged into a population code matrix. The population code matrix is factorized into a basis element matrix and a contribution coefficient matrix based on a number of basis vectors, where the number of basis vectors is selected to balance sparseness in the basis element matrix and reconstruction error of the population code matrix from the basis element matrix and the contribution coefficient matrix. When the basis vectors are used as a set of weights for a spiking neural network, the embodiments are compatible with neuromorphic hardware and can achieve compact representation of high-dimensional data, infer latent variables in the data, and defer processing to an off-line training phase to save time during real-time data capture and evaluation.

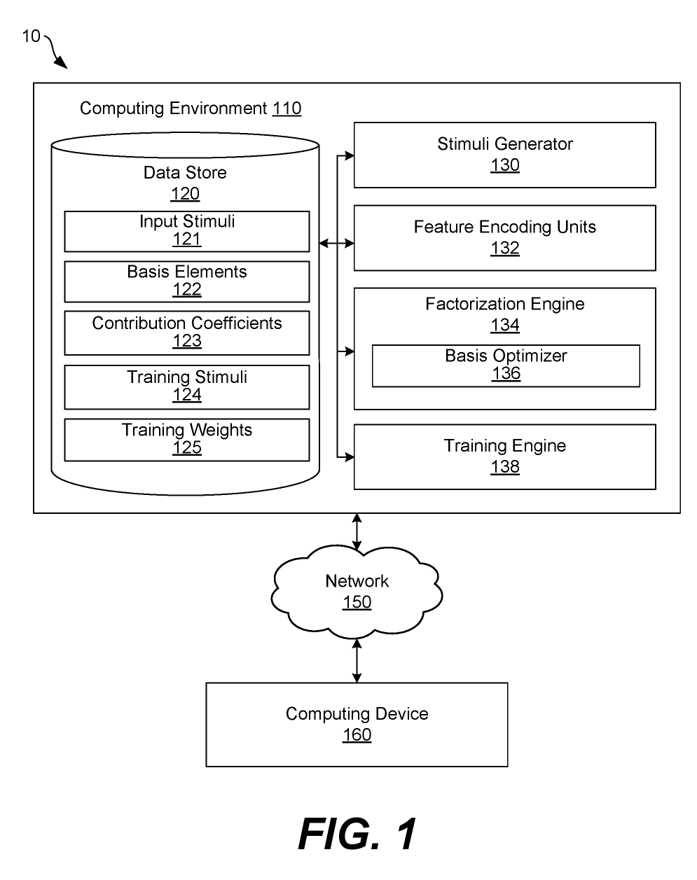

Turning to the drawings for a more detailed description of the embodiments, FIG. 1 illustrates an example system 10 for efficient neuromorphic population coding according to various examples described herein. The system 10 includes a computing environment 110, a network 150, and a computing device 160. FIG. 1 is representative of a system to implement the computational model described herein, but is not intended to limit the scope of the embodiments to any particular type or arrangement of computing or processing systems. For example, the organization of the components of the system 10, as described below, is representative and can vary.

The computing environment 110 can be embodied as one or more computing or processing devices or systems. As one example, the computing environment 110 can be embodied, at least in part, as a neuromorphic computing system, using a combination of analog and/or digital circuitry to mimic neuro-biological architectures present in the nervous system. Thus, the computing environment 110 can include a combination of analog, digital, and mixed-mode analog/digital circuitry and the associated software (e.g., computer-executable instructions) to implement the computational model described herein as a neural-based system (e.g., for visual perception, motor control, multisensory integration, etc.). Among other components, neuromorphic computing hardware can be realized using a combination of memristors, threshold switches, and transistors.

The computing environment 110 can be located at a single installation site or distributed among different geographical locations. The computing environment 110 can include a plurality of computing devices that together embody a hosted computing resource, a grid computing resource, and/or other distributed computing arrangement. In some cases, the computing environment 110 can be embodied as an elastic computing resource where an allotted capacity of processing, network, storage, or other computing-related resources vary over time. The computing environment 110 can also be embodied, in part, as computer-readable and -executable instructions (and the memory devices to store those instructions) to direct it to perform aspects of the embodiments described herein.

Among other representative components, the computing environment 110 includes a data store 120, stimuli generator 130, feature encoding units 132, factorization engine 134, and training engine 138. The data store 120 includes memory areas to store input stimuli 121, basis elements 122, contribution coefficients 123, training stimuli 124, and training weights 125. Among other components, the factorization engine 134 includes a basis optimizer 136. The operation of the components of the computing environment 110 are described in further detail below.

The computing device 160 can be embodied as one or more computing or processing devices or systems. In one example case, similar to the computing environment 110, the computing device 160 can be embodied, at least in part, as a neuromorphic computing system, using a combination of analog and/or digital circuitry to mimic neuro-biological architectures present in the nervous system. Thus, the computing environment 110 can include a combination of analog, digital, and mixed-mode analog/digital circuitry and the associated software to model neural systems. Among other components, neuromorphic computing hardware can be realized using memristors, threshold switches, and transistors.

The computing device 160 can be relied upon as the processing system in any number of devices or systems, such as desktop, laptop, or handheld computing devices, robots or other robotic devices, drones or other aircraft devices, automobiles or other transportation systems, appliances, etc., including devices or systems that rely upon autonomous or semi-autonomous neuromorphic-based control. The computing device 160 can include a number of input and output subsystems for interaction with its surroundings and environment. Among others, the subsystems can include one or more keypads, touch pads, touch screens, microphones, cameras or image sensors, displays, speakers, radio-frequency communications systems, global positioning systems (GPSs) motion tracking and orientation sensors (e.g., accelerometers, gyros, etc.), environmental sensors (e.g., light, temperature, pressure, etc.), other sensor arrays, and other peripherals and components to gather, process, and present data.

The computational model described herein can be developed, trained, and stored on the computing environment 110, and certain results of that development and training can be transferred to the computing device 160. In that way, the functionality of the computing device 160 can be extended, while the computational demands to develop the model can be shared among the computing environment 110 and the computing device 160. As one example, the computational model can be trained to recognize movement in various directions using a set of representative optic flow fields (e.g., input stimuli) that cover a range of features (e.g., forward motion, backward motion, direction of travel or heading, rotation, etc.) in a feature space (e.g., motion). Once training for the computational model is complete at the computing environment 110, the model can be transferred to the computing device 160. In turn, the computing device 160, which might be a drone that relies upon cameras for navigation, can process images using the computational model to help identify whether it is

The network 150 can include any suitable means for data communications between the computing environment 110 and the computing device 160, such as the Internet, intranets, extranets, wide area networks (WANs), local area networks (LANs), local buses (e.g., universal serial bus (USB)), wireless (e.g., cellular, 802.11-based (WiFi), bluetooth, etc.) networks, cable networks, satellite networks, other suitable networks, or any combinations thereof. Over the network 150, the computing environment 110 and the client device 160 can communicate with each other using any suitable systems interconnect models and/or protocols. Although not illustrated, the network 150 can include connections to any number of network hosts, such as website servers, file servers, networked computing resources, databases, data stores, or any other network or computing architectures.

Turning back to the computing environment 110, the stimuli generator 130 is configured to generate the input stimuli 121 to cover a range of features in a feature space. The computational model described herein can be trained to process many different types of data based, in part, on the design of the feature encoding units 132. As described in further detail below, the feature encoding units 132 can be designed to encode any number of features in various feature spaces into a population of encoded feature values, where each population (e.g., vector, array, group, or other logical arrangement) of encoded feature values indicates certain characteristics of at least one feature in a feature space. As input for processing, the stimuli generator 130 can generate a baseline set of the input stimuli 121 to be encoded by the feature encoding units 132.

As one example, the feature space can include flow-field-related features, such as combinations of translational, rotational, and deformational flow features, and the stimuli generator 130 can generate a baseline set of input stimuli 121 representative of those flow-field-related features. Flow field processing can be useful for the identification of forward, backward, direction of travel or heading, and rotational movement using cameras or other sensors. As another example, the feature space can include facial-related features, such as age, sex, expression, hairstyle, bone structure, and other related features. The stimuli generator 130 can generate a baseline set of input stimuli 121 representative of those facial-related features.

Additionally or alternatively, the baseline set of input stimuli 121 can be selected from a set of predetermined or measured stimuli, such as images captured during movement or portraits of various individuals. Once generated and/or collected by the stimuli generator 130, the input stimuli 121 can be stored in the data store 120 for further processing by the feature encoding units 132 and the factorization engine 134, for example.

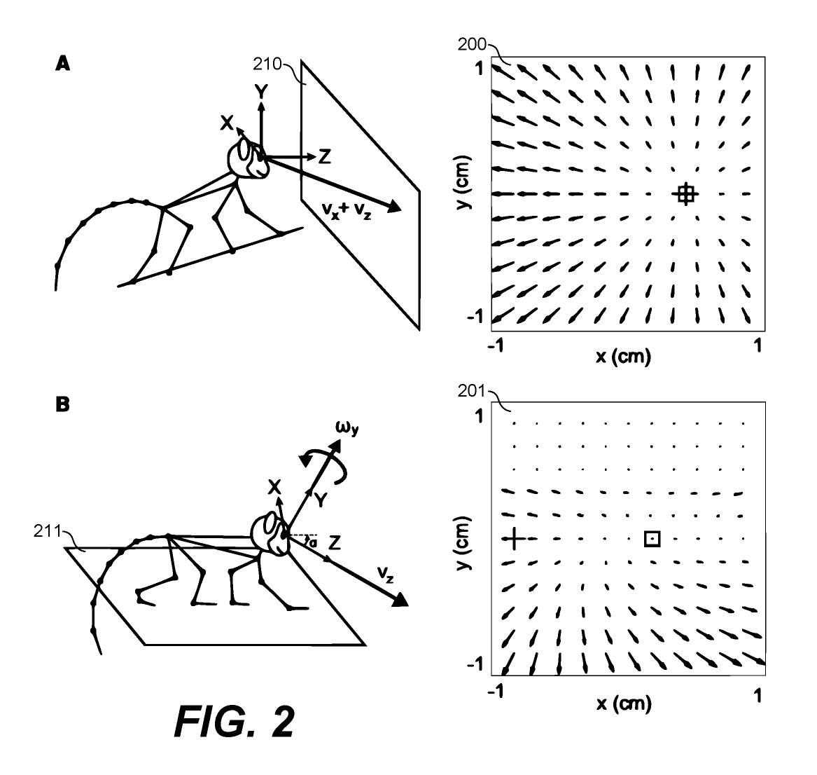

Taking optic flow fields as a particular example, FIG. 2 illustrates representative flow fields 200 and 201 generated by the stimuli generator 130. With the flow fields 200 and 201 being representative, the stimuli generator 130 can be configured to generate a number of 15×15 pixel arrays and store them in the data store 120 as the input stimuli 121. The pixel arrays simulate optic flow and simulate apparent motion on a retina or image sensor (an observer), for example, that would be caused by an observer undergoing translations and rotations in 3D space. Thus, the stimuli generator 130 can be embodied as a type of motion field model, where a pinhole camera with focal length f is used to project 3D real-world points \vec{P}=[X, Y, Z]^{t} onto a 2D image plane \vec{p}=[x,y]^{t}=f/Z[X,Y]^{t}.

Local motion at a particular position \vec{p} on the image plane can be specified by the stimuli generator 130 by a vector \vec{\dot{p}}=[\dot{x},\dot{y}]^{t}, with local direction and speed of motion given as tan⁻¹(\dot{y}/\dot{x}) and ∥\vec{\dot{x}}∥, respectively. The vector \vec{\dot{p}} can be expressed by the sum of a translational flow component. \vec{\dot{x}}_{T}=[\dot{x}_{T},\dot{y}_{T}]^{t}, and a rotational flow component, \vec{\dot{x}}_{R}=[\dot{x}_{R},\dot{y}_{R}]^{t}, given by:

$$[ \begin{matrix}\dot{x} \\ \dot{y}\end{matrix} ] = [ \begin{matrix}{\dot{x}}_{T} \\ {\dot{y}}_{R}\end{matrix} ] + [ \begin{matrix}{\dot{x}}_{R} \\ {\dot{y}}_{R}\end{matrix} ] , \qquad ( 1 )$$

where the translational component depends on the observer's linear velocity,
\vec{v}=[vₓ, v_{y}, v_{z}]^{t}, and the rotational component depends on the observer's angular velocity, \vec{ω}=[ωₓ, ω_{y}, ω_{z}]^{t}, given by:

$$\begin{matrix}[ \begin{matrix}{\dot{x}}_{T} \\ {\dot{y}}_{T}\end{matrix} ] = \frac{1}{Z} [ \begin{matrix}- f & 0 & x \\ 0 & - f & y\end{matrix} ] [ \begin{matrix}{v}_{x} \\ {v}_{y} \\ {v}_{z}\end{matrix} ] and & ( 2 ) \\ [ \begin{matrix}{\dot{x}}_{R} \\ {\dot{y}}_{R}\end{matrix} ] = \frac{1}{f} [ \begin{matrix}xy & - ( {f}^{2} + {x}^{2} ) & fy \\ ( {f}^{2} + {y}^{2} ) & - xy & - fx\end{matrix} ] [ \begin{matrix}{ω}_{x} \\ {ω}_{y} \\ {ω}_{z}\end{matrix} ] . & ( 3 )\end{matrix}$$

In the simulations, f=0.01 m and x,yε[−0.01 m,0.01 m]. The 15×15 pixel arrays thus subtend 90°×90° of visual angle.

Flow fields that mimic natural viewing conditions can be sampled by the stimuli generator 130 during locomotion over a ground plane 200 (tilted α=−30° down from the horizontal) and toward a back plane 201 as shown in FIG. 2. Linear velocities correspond to comfortable walking speeds ∥\vec{v}∥={0.5, 1, 1.5} meters per second, and angular velocities correspond to common camera rotation velocities for gaze stabilization ∥\vec{ω}∥={0, ±5, ±10} degrees per second. Movement directions can be uniformly sampled by the stimuli generator 130 from all possible 3D directions (including backward translations). The back and ground planes 200 and 201 can be located at distances d=(2, 4, 8, 16, 32) meters from the observer. This interval of depths was exponentially sampled due to the reciprocal dependency between depth and the length of vectors of the translational visual motion field according to Equation 2.

Note that \vec{\dot{x}}_{T} depends on the distance to the point of interest (Z) (see, e.g., Equation 2), but \vec{\dot{x}}_{R} does not (see, e.g., Equation 3). The point at which \vec{\dot{x}}_{T}=0 is referred to as the epipole or center of motion (COM) and is designated by a box in FIG. 2. If the optic flow stimulus is radially expanding, as is the case for translational forward motion, the COM is called the focus of expansion (FOE). In the absence of rotational flow, the FOE coincides with the direction of travel, or “heading” (see, e.g., “A” in FIG. 2). However, in the presence of rotational flow, the FOE appears shifted with respect to the true direction of travel (see, e.g., “B” in FIG. 2).

As indicated above, the stimuli generator 130 can be configured to generate input stimuli 121 other than flow fields as shown in FIG. 2 and described above. The flow fields shown in FIG. 2 are not presented to suggest that the computational model described herein is limited to use with any particular type of data or feature space. Regardless of the type of feature space associated with the input stimuli 121, the stimuli generator 130 can be configured to generate a broad, encompassing range of input stimuli 121 that cover a large number (e.g., to the extent possible) of the features in the feature space under examination. In other words, the stimuli generator 130 can be designed to generate a set of input stimuli 121 that exhibit a range of other features in feature spaces, including simulated, artificial, and/or real-world conditions.

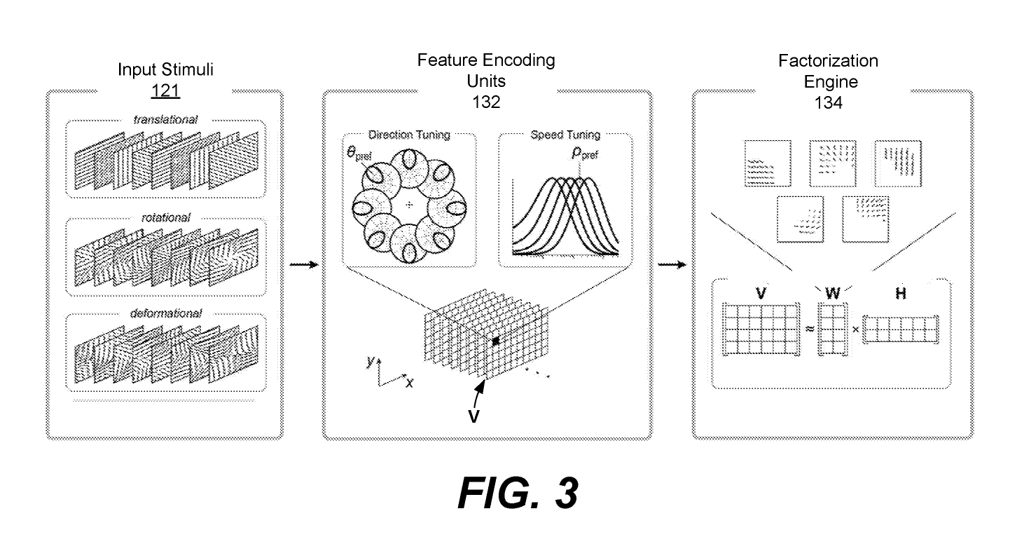

FIG. 3 illustrates a representative example of certain components in the computing environment 110. As shown, once the input stimuli 121 are generated by the stimuli generator 130, they can be processed by the feature encoding units 132. Generally, the computational model described herein can be trained to process any input stimuli 121 that the feature encoding units 132 are capable of interpreting and encoding into a population of encoded feature values. The feature encoding units 132 are configured to evaluate individual instances of the input stimuli 121 to generate a population of encoded feature values for each of input stimuli 121 (e.g., each the flow fields 200 and 201, among others).

The feature encoding units 132 can be embodied as an array of encoding units, each selective or sensitive to a particular aspect of a feature in the feature space of the input stimuli 121. Thus, the flow fields 200 and 201, among others in the input stimuli 121, are each processed by an array of feature encoding units 132. In the context of flow fields, each feature encoding unit 132 may be selective to a particular direction of motion, θ_{pref}, and a particular speed of motion, ρ_{pref}, at a particular spatial location, (x,y). The activity output of each feature encoding unit 132 unit, γ_{MT}, can be given as:

r_{MT}(x,y;θ_{pref},ρ_{pref})=d_{MT}(x,y;θ_{pref})s_{MT}(x,y;ρ_{pref}), (4)

where d_{MT} was the unit's direction response and S_{MT} was the unit's speed response.

The direction tuning output of each feature encoding unit 132 can be given as a von Mises function based on the difference between the local direction of motion at a particular spatial location, θ(x,y), and the unit's preferred direction of motion, θ_{pref}, as:

d_{MT}(x,y;θ_{pref})=exp(σ_{θ}(cos(θ(x,y)−θ_{pref})−1)), (5)

where the bandwidth parameter is σ_{θ}=3, so that the resulting tuning width (full width at half-maximum) can be about 90°.

The speed tuning output of each feature encoding unit 132 can be given as a log-Gaussian function of the local speed of motion, ρ(x,y), relative to the unit's preferred speed of motion, ρ_{pref}, as:

$${s}_{MT} ( x , y ; {ρ}_{pref} ) = exp ( - \frac{{log}^{2} ( \frac{ρ ( x , y ) + {s}_{0}}{{ρ}_{pref} + {s}_{0}} )}{2 {σ}_{ρ}^{2}} ) , \qquad ( 6 )$$

where the bandwidth parameter is σ_{ρ}=1.16 and the speed offset parameter is s₀=0.33, both of which correspond to the medians of physiological recordings. Note that the offset parameter, so, might be necessary to keep the logarithm from becoming undefined as stimulus speed approached zero.

As a result, the population prediction of speed discrimination thresholds obeyed Weber's law for speeds larger than ˜5°/s. 5 octave-spaced bins and a uniform distribution between 0.5 deg/s and 32 deg/s can be selected, at ρ_{pref}={2, 4, 8, 16, 32} degrees per second.

In one example case, a total of 40 feature encoding units 132 (selective for eight directions vs. five speeds of motion) can be used at each spatial location in the pixel arrays of the input stimuli 121, yielding a total of F=15×15×8×5=9000 feature encoding units 132 for each input stimuli 121. The encoded outputs of the feature encoding units 132 for a particular input stimuli 121 instance comprises a population of encoded feature values. Each population of encoded values is representative of the local direction and speed of motion exhibited by a particular the input stimuli 121.

The feature encoding units 132 are also configured to arrange the population of encoded values into a population code matrix V. In one example, the populations of encoded feature value outputs from the feature encoding units 132 for each of the input stimuli 121 are arranged into the columns of an F×S population code matrix, V, which serves as an input to the factorization engine 134.

The factorization engine 134 is configured to perform a dimensionality reduction method, such as NMF, on the population code matrix V. NMF can be used to decompose multivariate data into an inner product of two reduced-rank matrices. More particularly, NMF is an algorithm used in multivariate analysis and linear algebra where a matrix V is factorized into matrices W and H, with the property that all three matrices have no negative elements. This non-negativity makes the resulting matrices easier to inspect and, in certain fields such as processing audio spectrograms or muscular activity, non-negativity is inherent to the data being considered. NMF thus finds applications in computer vision, audio signal processing, and other fields. The non-negativity constraints of NMF enforce the combination of different basis vectors to be additive, leading to representations that are often parts-based and sparse. When applied to neural networks, these non-negativity constraints correspond to the notion that neuronal firing rates are never negative and that synaptic weights are either excitatory or inhibitory, but they do not change sign.

Like principal component analysis (PCA), the goal of NMF is then to find a decomposition of the data matrix V, with the additional constraint that all elements of the matrices W and H be non-negative. In contrast to independent component analysis (ICA), NMF does not make any assumptions about the statistical dependencies of W and H. The resulting decomposition is not exact, as WH is a lower-rank approximation to V, and the difference between WH and V is termed the reconstruction error. Perfect accuracy is only possible when the number of basis vectors approaches infinity, but good approximations can usually be obtained with a reasonably small number of basis vectors.

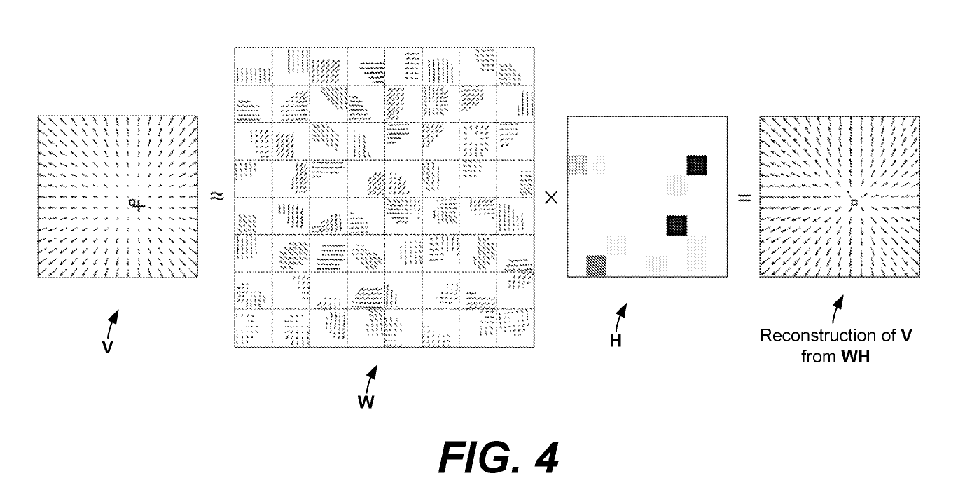

FIG. 4 illustrates a representative example of factorization used for efficient neuromorphic population coding according to various examples described herein. As shown in FIG. 4, the factorization engine 134 can be configured to linearly decompose the population code matrix V into an inner product of two reduced-rank matrices using NMF, including a basis element matrix W and a contribution coefficient matrix H, such that V≈WH. The basis element matrix W can be stored in the data store 120 as the basis elements 122, and the contribution coefficient matrix H can be stored in the data store 120 as the contribution coefficients 123.

The basis element matrix W contains as its columns a total of B nonnegative basis vectors of the decomposition. The contribution coefficient matrix H contains as its rows the contribution of each basis vector in the input vectors (e.g., hidden coefficients). These two matrices are found by iteratively reducing the residual between V and WH using an alternating non-negative least-squares method.

The columns of the basis element matrix W can be interpreted as the weight vectors of B feature encoding units 132. Each weight vector has F elements representative of the weights from a number of the feature encoding units 132. The optimization problem can be solved, for example, by an alternating least-squares algorithm that aims to iteratively minimize the root-mean-squared residual D between V and WH, given as:

$$D = \frac{‖ V - WH ‖}{\sqrt{FS}} , \qquad ( 7 )$$

where F is the number of rows in W and S is the number of columns in H. W and H were normalized so that the rows of H had unit length.

One open parameter of the NMF algorithm is the number of basis vectors B. The basis optimizer 136 is configured to identify a number of basis vectors B to be used in the factorization of the population code matrix V into W and H matrices, while balancing the competing concerns of sparseness in the basis element matrix W and error in the reconstruction of V from W and H (e.g., the root-mean-squared residual error D given in Equation 7).

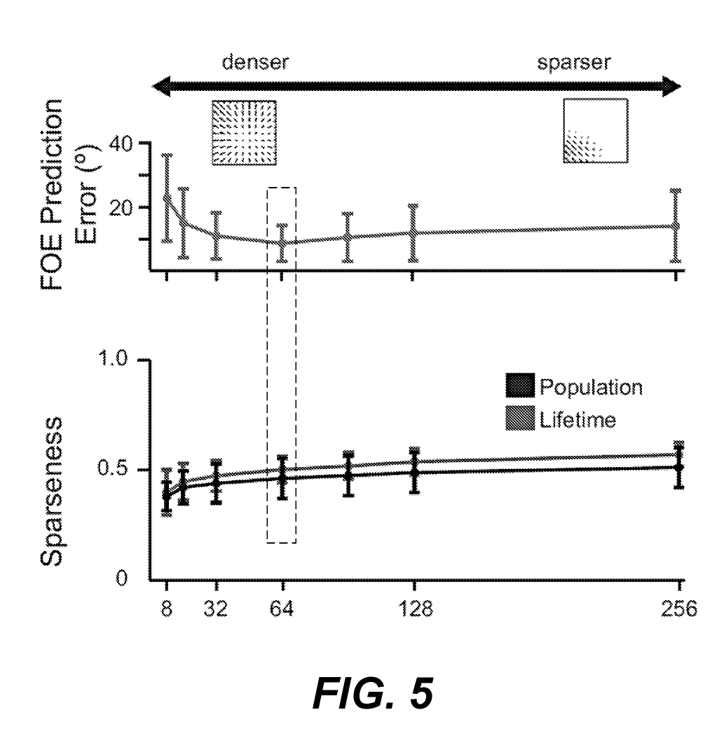

In simulations, a range of values (B=2ⁱ, where i={4, 5, 6, 7, 8}) were attempted for the NMF algorithm, and B=64 was identified as a suitable number of basis vectors to co-optimize for both accuracy and efficiency of encoding, although other numbers of basis vectors might be more suitable in other cases. In that context, FIG. 5 illustrates the selection of a number of basis vectors B for factorization. At the top, FIG. 5 illustrates FOE, direction of travel, or “heading” error as a function of the number of basis vectors B over a ten-fold cross-validation. At the bottom. FIG. 5 illustrates population and sparseness as a function of the number of basis vectors B. As the number of basis vectors B increases, the basis element matrix W becomes sparser. At the same time, however, B=64 basis vectors leads to a relative minimum in FOE error. Thus, applying the NMF algorithm model with B=64 basis vectors co-optimizes for both accuracy and efficiency of encoding in the basis element matrix W.

A sparseness metric for the basis element matrix W can be determined according to the following definition of sparseness:

$$s = ( 1 - \frac{1}{N} \frac{{( {\sum }_{i} {r}_{i} )}^{2}}{{\sum }_{i} {r}_{i}^{2}} ) / ( 1 - \frac{1}{N} ) . \qquad ( 8 )$$

In Equation 10, sε[0,1] is a measure of sparseness for a signal r with N sample points, where s=1 denotes maximum sparseness and is indicative of a local code, and s=0 is indicative of a dense code. To measure how many elements of the basis element matrix W will be activated by any given stimulus (e.g., population sparseness), rᵢ was the response of the i-th cell to a particular stimulus and N was the number of model units. In order to determine how many stimuli any given model unit responded to (lifetime sparseness), rᵢ was the response of a unit to the i-th cell to a particular stimulus and N was the number of stimuli. Population sparseness was averaged across stimuli and lifetime sparseness was averaged across units.

The basis optimizer 136 is thus configured to identify a number of basis vectors B to minimize the reconstruction error in the population code matrix V while, at the same time, account for sparseness in the basis element matrix W. In some cases, the number of basis vectors can be determined in an iterative fashion through the evaluation of the NMF algorithm a number of times with different numbers of basis vectors B.

After the factorization engine 134 has factorized the population code matrix V into the basis element matrix W and the contribution coefficient matrix H (and the number of basis vectors B has been selected), the first training phase of the computational model is complete. As shown in a representative fashion in FIG. 4, the basis element matrix W includes information to recreate or reconstruct a range of features exhibited in the input stimuli 121.

The training engine 138 can interpret the resulting columns of the basis element matrix W as weight vectors from the feature encoding units 132 to create a set of B training engine units. In the context described above, these training engine units are conceptually equivalent to MSTd neurons. The activity of the b-th training engine unit, r_{MSTd}, can thus be described as the dot product of response of the feature encoding units 132 to a particular input stimuli 121 and the unit's corresponding nonnegative weight vector:

r_{MSTd}^{b}(i)=\vec{v}^{(t)}\vec{w}^{(b)}, (9)

where \vec{v}⁽ⁱ⁾ is the i-th column of V and \vec{w}^{(b)} was the b-th column of W.

In a second training phase of the computational model, the training engine units can be used to train a network to perform some function, such as head to a target, avoid an obstacle, find an object, etc. The training engine 138 is configured to evaluate a set of training stimuli 124 against the training engine units using supervised learning to determine one or more sets of training weights 125. The training weights 125 can be used to identify, in the training stimuli 124, a number of different features present in the feature space of the original input stimuli 121. Thus, during the first training phase, the basis element matrix W is constructed using a range of input stimuli 121 having a number of different features. Discarding H, the basis element matrix W is then used to create a set of B training engine units, which, in during the second training phase, are used to generate training weights 125 encoded to be representative of features in the training stimuli 124, where those features correspond to features originally exhibited by the input stimuli 121.

Perceptual variables (i.e., hidden or latent variables) such as heading or angular velocity can thus be decoded from the training engine units using supervised learning algorithms, the simplest of which being linear regression. To that end, a set of training stimuli 124 was assembled consisting of 10⁴ flow fields with randomly selected headings, which depicted linear observer movement (velocities sampled uniformly between 0.5 m's and 2 m/s; no eye rotations) towards a back plane located at various distances d={2, 4, 8, 16, 32} meters away. As part of a ten-fold cross-validation procedure, stimuli were split repeatedly into a training set containing 9000 stimuli and a test set containing 1000 stimuli. Using linear regression or another approach, a set of training weights 125 can be obtained to decode population activity in the training engine units in response to samples from the training stimuli 124.

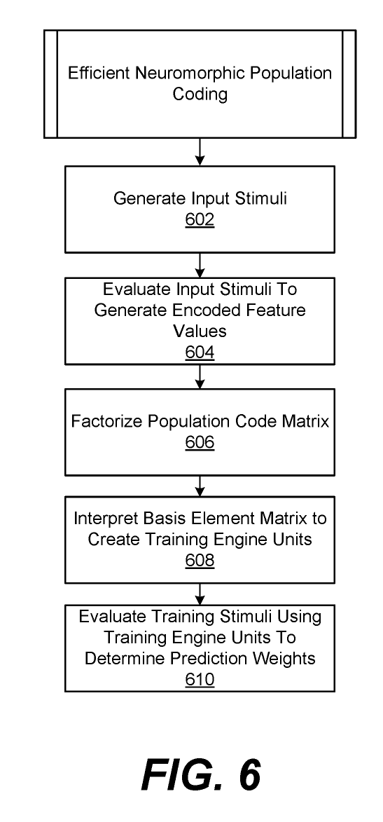

FIG. 6 illustrates an example efficient neuromorphic population coding process according to various examples described herein. The process illustrated in FIG. 6 is described in connection with computing environment 110 shown in FIG. 1, although other computing devices or environments could perform the process. Although the process show an order of execution, the order of execution can differ from that which is shown. For example, the order of execution of two or more elements can be switched relative to the order shown. As other examples, two or more elements shown in succession can be executed concurrently or with partial concurrence, and one or more of the elements can be skipped or omitted.

At step 602, the process includes the stimuli generator 130 generating a set of the input stimuli 121 to cover a range of features in a feature space. As described above, the stimuli generator 130 can generate a baseline set of input stimuli 121 representative of flow-field-related features, such as combinations of translational, rotational, and deformational flow features. As another example, the stimuli generator 130 can generate a baseline set of input stimuli 121 representative of facial-related features, such as age, sex, expression, hairstyle, bone structure, and other related features. The input stimuli 121 can be stored in the data store 120 for further processing in later steps.

At step 604, the process includes the feature encoding units 132 evaluating the input stimuli 121 to generate a population of encoded feature values. The feature encoding units 132 can evaluate individual instances of the input stimuli 121 to generate, for each input stimuli 121 instance, a population of encoded feature values. At step 604, the process can also include the feature encoding units 132 arranging the population of encoded values for each of the individual input stimuli 121 into a population code matrix V, as described above.

At step 606, the process includes the factorization engine 134 factorizing the population code matrix V into a basis element matrix W and a contribution coefficient matrix H. As described above, NMF factorization can be used at step 606, but the process shown in FIG. 6 is not limited to the use of NMF factorization. At step 606, the process can also include the basis optimizer 136 identifying a number of basis vectors B to be used when factorizing the population code matrix V into W and H matrices, while balancing the competing concerns of sparseness in the basis element matrix W and error in the reconstruction of V from W and H. The basis optimizer 136 is thus configured to identify a number of basis vectors B to minimize the reconstruction error in the population code matrix V while, at the same time, account for sparseness in the basis element matrix W. In some cases, the number of basis vectors can be determined in an iterative fashion through the evaluation of the NMF algorithm a number of times with different numbers of basis vectors B.

At step 608, the process includes the training engine 138 interpreting the resulting columns of the basis element matrix W as weight vectors from the feature encoding units 132 to create a set of B training engine units. As described above, the activity of the b-th training engine unit, r_{MSTd}^{b}, can be described as the dot product of response of the feature encoding units 132 to a particular input stimuli 121 and the unit's corresponding nonnegative weight vector according to Equation 9.

At step 610, the process includes the training engine 138 further evaluating a set of training stimuli 124 against the training engine units using regression to determine one or more sets of training weights 125. The training weights 125 can be used to identify, in the training stimuli 124, a number of different features present in the feature space of the original input stimuli 121. Thus, during the first training phase, the basis element matrix W is constructed using a range of input stimuli 121 having a number of different features. During the second training phase, the basis element matrix W is used to generate training weights 125 encoded to be representative of features in the training stimuli 124, where those features correspond to features originally exhibited by the input stimuli 121. The training weights 125 can be used to quickly identify features in new, possibly observed, data beyond the input stimuli 121 and/or the training stimuli 124.

The flowchart in FIG. 6 shows examples of the functionality and operation of implementations of components described herein. The components described herein can be embodied in hardware, software, or a combination of hardware and software. If embodied in software, each element can represent a module of code or a portion of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

The computing environment 110 can include at least one processing circuit. Such a processing circuit can include, for example, one or more processors, including neuromorphic processors or processing circuitry, and one or more storage or memory devices coupled to a local interface. The local interface can include, for example, a data bus with an accompanying address/control bus or any other suitable bus structure.

The memory devices can store data or components that are executable by the processors of the processing circuit. For example, the stimuli generator 130, feature encoding units 132, factorization engine 134, training engine 138, and/or other components can be stored in one or more memory devices and be executable by one or more processors in the computing environment 10. Also, a data store, such as the data store 120 can be stored in the one or more memory devices.

The stimuli generator 130, feature encoding units 132, factorization engine 134, training engine 138, and/or other components described herein can be embodied in the form of hardware, as software components that are executable by hardware, or as a combination of software and hardware. If embodied as hardware, the components described herein can be implemented as a circuit or state machine that employs any suitable hardware technology, including neuromorphic hardware. The hardware technology can include, for example, one or more memristors, threshold switches, transistors, logic circuits for implementing various logic functions, application specific integrated circuits (ASICs) having appropriate logic gates, programmable logic devices (e.g., field-programmable gate array (FPGAs), etc.

Also, one or more or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein, including the stimuli generator 130, feature encoding units 132, factorization engine 134, and training engine 138 can be implemented and structured in a variety of ways. For example, one or more applications described can be implemented as modules or components of a single application. Further, one or more applications described herein can be executed in shared or separate computing devices or a combination thereof.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

1. A method for efficient neuromorphic population coding, comprising:
evaluating, by a computing device, individual input stimuli instances among a set of input stimuli using a set of feature encoding units to generate a population of encoded feature values for each of the individual input stimuli;
arranging, by the computing device, the population of encoded values for each of the individual input stimuli into a population code matrix; and
factorizing, by the computing device, the population code matrix into a basis element matrix and a contribution coefficient matrix based on a number of basis vectors, the number of basis vectors being selected as a balance between sparseness and reconstruction error of the input stimuli.

2. The method according to claim 1, further comprising generating a set of input stimuli to cover a range of features in a feature space.

3. The method according to claim 2, wherein the set of input stimuli comprises at least one translational, rotational, or deformational optic flow stimuli.

4. The method according to claim 2, wherein the set of input stimuli comprises at least one facial-related feature stimuli.

5. The method according to claim 2, further comprising evaluating a set of training stimuli against the basis element matrix using a learning method to determine a set of weights to perform a task.

6. The method according to claim 1, wherein factorizing the population code matrix comprises identifying the number of basis vectors to co-optimize for accuracy, sparseness, and efficiency of encoding in the basis element matrix.

7. The method according to claim 1, wherein the factorizing comprises non-negative matrix factorizing.

8. The method according to claim 1, wherein the population code can be converted to a weight matrix compatible with a neuromorphic computing device.

9. A system for efficient neuromorphic population coding, comprising:
a memory device comprising computer-readable instructions stored thereon; and
a computing device configured through execution of the computer-readable instructions, to:
evaluate individual input stimuli instances among a set of input stimuli using a set of feature encoding units to generate a population of encoded feature values for each of the individual input stimuli;
arrange the population of encoded values for each of the individual input stimuli into a population code matrix; and
factorize the population code matrix into a basis element matrix and a contribution coefficient matrix based on a number of basis vectors, the number of basis vectors being selected as a balance between sparseness in the basis element matrix and minimized error between a reconstruction of the population code matrix from the basis element matrix and the contribution coefficient matrix.

10. The system according to claim 9, wherein the computing device receives a set of input stimuli that cover a range of features in a feature space.

11. The system according to claim 10, wherein the set of input stimuli comprises at least one translational, rotational, or deformational optic flow stimuli.

12. The system according to claim 10, wherein the set of input stimuli comprises at least one facial-related feature stimuli.

13. The system according to claim 10, wherein the computing device is further configured to evaluate a set of training stimuli against the basis element matrix using regression to determine a set of weights to perform a function using the basis vectors.

14. The system according to claim 9, wherein the computing device is further configured to identify the number of basis vectors to co-optimize for both accuracy and efficiency of encoding in the basis element matrix.

15. The system according to claim 14, wherein the computing device is further configured to factorize the population code matrix using non-negative matrix factorizing.

16. The system according to claim 9, wherein the computing device comprises a neuromorphic computing device.

17. A non-transitory computer-readable medium including computer-readable instructions for efficient neuromorphic population coding stored thereon that, when executed by a computing device, directs the computing device to perform a method, comprising:
evaluating, by the computing device, individual input stimuli instances among a set of input stimuli using a set of feature encoding units to generate a population of encoded feature values for each of the individual input stimuli;
arranging, by the computing device, the population of encoded values for each of the individual input stimuli into a population code matrix; and
factorizing, by the computing device, the population code matrix into a basis element matrix and a contribution coefficient matrix based on a number of basis vectors, the number of basis vectors being selected as a balance between sparseness in the basis element matrix and minimized error between a reconstruction of the population code matrix from the basis element matrix and the contribution coefficient matrix.

18. The non-transitory computer-readable medium according to claim 17, the method further comprising generating a set of input stimuli to cover a range of features in a feature space.

19. The non-transitory computer-readable medium according to claim 18, the method further comprising evaluating a set of training stimuli against the basis element matrix using regression to determine a set of weights for prediction of at least one feature in the feature space.

20. The non-transitory computer-readable medium according to claim 17, wherein factorizing the population code matrix comprises identifying the number of basis vectors to co-optimize for both accuracy and efficiency of encoding in the basis element matrix.
